(19) United States
(12) Patent Application Publication
(10) Pub. No.: US 2006/0060045 A1
(43) Pub. Date: Mar. 23, 2006

(54) Method and apparatus for cutting sheet metal

(76) Inventor: Wilf Koenders, Englefeld (CA)

Correspondence Address: FROST BROWN TODD, LLC, 2200 PNC CENTER, 201 E. FIFTH STREET, CINCINNATI, OH, 45202, US

(21) Appl. No.: 11/238,288

(22) Filed: Sep. 29, 2005

Related U.S. Application Data
(63) Continuation-in-part of application No. 10/032,521, filed on Oct. 19, 2001.

(30) Foreign Application Priority Data
Oct. 19, 2000 (CA) 2,32,3965

(51) Int. Cl. B26D 1/00

(52) U.S. Cl. 83/13

(57) ABSTRACT

An apparatus for cutting sheet metal pieces from a sheet metal coil comprises a coil support adapted to support the sheet metal coil such that same may rotate about the coil axis to unroll an end portion of the sheet metal coil and a sheet support adapted to support the end portion for cutting. A cutting head is mounted above the end portion and is operative to cut through the end portion. A cutting head drive is operative to move the cutting head back and forth along a first path parallel to the coil axis and a sheet metal drive is operative to move the end portion forward and rearward along a second path perpendicular to the coil axis. A computer is operative to control and coordinate the sheet metal drive and the cutting head drive such that the pieces are cut from the end portion.

This application is a continuation-in-part of U.S. patent application Ser. No. 10/032,521 METHOD AND APPARATUS FOR CUTTING SHEET METAL. This invention is in the field of metal working and in particular cutting sheet metal.

### BACKGROUND OF THE INVENTION

Sheet metal is generally available either in plates or coils of various sizes. The user generally cuts the pieces he requires from the plate or coil.

Computerized cutting tables are presently available wherein a plate of sheet metal is laid on the table, and cuts through the plate are made in an X-Y grid to obtain the required pieces. A cutting head, using oxygen/acetylene, laser, water, plasma or the like, is mounted on a carriage above the table and controlled by the computer to move in both the X and Y directions in a coordinated fashion to keep the speed of the cutting head relative to the plate substantially constant. The shape of the desired piece, or of many different pieces, is programmed into the computer and the X and Y movements of the cutting head result in the programmed pieces being cut from the plate.

The cutting head must be movable both across the width of the plate and along the length of the plate. These tables are therefore quite complex and expensive, especially for use on larger plates. It is generally desirable to use a larger plate as the computer can be programmed to cut the required pieces with less waste. There is almost always some waste at the end of the plate, as the plates most commonly come in standard sizes, and so the user must arrange the cuts to make the most from the given plate. The cutting tables also only accommodate certain sized plates.

The surface of the table must generally be cleaned of cutting debris before a new plate can be positioned. This cleaning and positioning takes time.

### SUMMARY OF THE INVENTION

It is the object of the present invention to provide an apparatus for cutting sheet metal pieces from a sheet metal coil more economically and with less waste than present apparatuses for cutting such pieces from a sheet metal plate.

It is a further object of the invention to provide such an apparatus wherein the cutting head moves only along a line above the sheet metal, and the sheet metal is moved perpendicular to that line to provide for cutting in an X-Y plane such that pieces may be cut from the sheet metal.

The invention provides, in one aspect, an apparatus for cutting sheet metal pieces from a sheet metal coil having a coil axis. The apparatus comprises a coil support adapted to support the sheet metal coil such that same may rotate about the coil axis to unroll an end portion of the sheet metal coil and a sheet support adapted to support the end portion for cutting. A cutting head is mounted above the sheet support and end portion and is operative to cut through the end portion. A cutting head drive is operative to move the cutting head back and forth along a first path parallel to the coil axis and a sheet metal drive is operative to move the end portion forward and rearward along a second path perpendicular to the coil axis. A coil drive is operable to selectively rotate the sheet metal coil about the coil axis in a forward direction and in a reverse direction. A computer is operative to control and coordinate the sheet metal drive and the cutting head drive such that the pieces are cut from the end portion.

The coil drive may be controlled by the computer so that a slack portion of sheet metal is provided between the sheet metal coil and the sheet metal drive. The sheet metal drive then does not have to rotate the sheet metal coil but only moves a portion of sheet metal forwards and rearwards. The inertia of the sheet metal coil can be quite substantial where the coil is large, leading to slippage and jerky motion of the sheet metal where the inertia must be overcome by the sheet metal drive.

The invention provides, in a second aspect, a method of cutting sheet metal pieces from a sheet metal coil, the sheet metal coil having a coil axis. The method comprises positioning an end portion from the sheet metal coil to rest on a sheet support; moving a cutting head back and forth above the end portion and the sheet support along a first path parallel to the coil axis to cut the end portion; moving the end portion forward and rearward along a second path perpendicular to the coil axis; rotating the sheet metal coil to maintain a slack portion of sheet metal between the sheet metal drive and the sheet metal coil; and coordinating the movements of the cutting head and the sheet metal along the first and second paths such that the pieces are cut from the sheet metal.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a top view of an embodiment of the invention showing only the essential elements of the apparatus;

FIG. 2 is an end view of the embodiment of FIG. 1;

FIG. 3 is a side view of the embodiment of FIG. 1;

FIG. 4 is a schematic top view of guide rollers as they could be added to the embodiment of FIG. 1;

FIG. 5 is a schematic side view showing alternate measuring wheels to determine the position of the sheet metal on the Y-axis;

FIG. 6 is a side view of an alternate embodiment of the invention showing a minimum slack portion of sheet metal;

FIG. 7 is a side view of the embodiment of FIG. 6 showing a maximum slack portion of sheet metal;

FIG. 8 is schematic side view of a further alternate embodiment of the invention.

### DETAILED DESCRIPTION OF THE ILLUSTRATED EMBODIMENTS

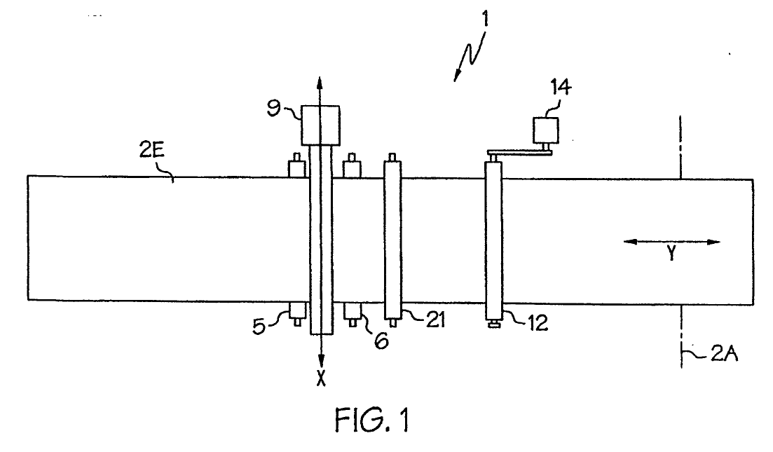

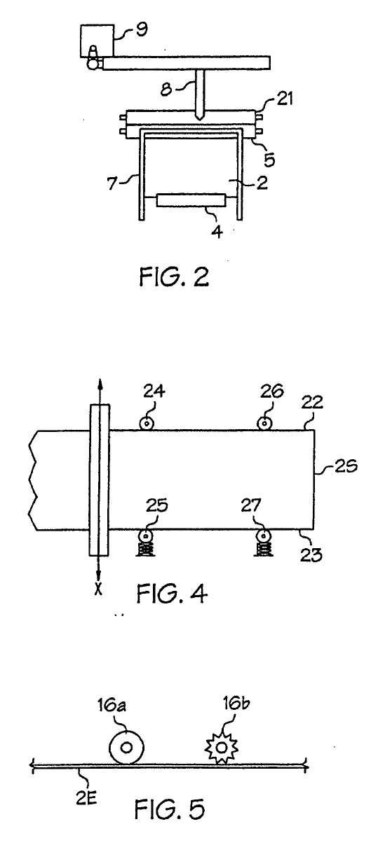

FIGS. 1-3 illustrate an apparatus 1 for cutting sheet metal pieces from a sheet metal coil 2 having a coil axis 2A. In the apparatus 1 of FIGS. 1-3 a coil support comprises coil rollers 3 and 4 which support the sheet metal coil 2 such that same may rotate about the coil axis 2A to unroll an end portion 2E. An alternate coil support is described below.

A sheet support, as illustrated comprising a pair of support rollers 5, 6, and table 7, supports the end portion 2E for cutting. Further rollers, or other supports may be substituted for the table 7, or for short pieces the table might be removed. The size and shape of the pieces being cut will dictate what support is needed for the end portion 2E.

A cutting head 8 is mounted above the support rollers 5, 6 and end portion 2E resting thereon, and is operative to cut through the end portion 2E. A cutting head drive 9 is operative to move the cutting head 8 back and forth along a first path X parallel to the coil axis 2A. The cutting head 8 can be oxygen/acetylene, plasma, pressurized water, laser or any such conventional cutting head.

The support rollers 5, 6 define an open space 10 beneath the end portion 2E under the first path X such that cutting debris can fall through the open space 10. The cutting head 8 moves only over this open space 10 as well, avoiding the problem in conventional tables where the cutting head passes over various support members under the plate, causing damage to the members and requiring repair or replacement after some usage.

A sheet metal drive 11 comprises a pair of upper and lower drive rollers 12, 13 driven by sheet drive motor 14. The end portion 2E passes between the drive rollers 12, 13. The sheet metal drive 11 moves the end portion 2E forward and rearward along a second path Y perpendicular to the coil axis 2A. The illustrated drive rollers 12, 13 extend right across the end portion 2E, however same could engage only a portion of the width of the end portion 2E. Other sheet metal driving mechanisms could be used as well.

A computer 15 is operative to control and coordinate the cutting head drive 9 and the sheet metal drive 11 such that the pieces are cut from the end portion 2E. The computer 15 performs essentially the same functions as that of a conventional computerized cutting table. Instead of moving the cutting head in both the first and second paths X, Y as in the conventional apparatus, the computer moves the cutting head back and forth along the first path X and moves the end portion 2E of sheet metal back and forth along the second path Y. As in the conventional apparatus, various shapes of pieces required may be programmed into the computer 15, which will then coordinate movement of the cutting head 8 relative to the end portion 2E in the X and Y paths to cut the pieces.

The computer can take information respecting the position of the end portion along the Y path from the drive rollers 12, 13 or alternatively the apparatus 1 can further comprise an independent measuring device operable to transmit information respecting the position of the end portion 2E along the second path Y to the computer 15 so that the computer can use this information to control the sheet metal drive 11. In this manner, any slippage of the drive rollers 12, 13 will not affect the accuracy of the apparatus. As illustrated in FIG. 5 the measuring device can comprise a wheel 16 bearing against a surface of the end portion 2E. The wheel 16 comprises a resilient circumferential surface, as in 16a, a plurality of teeth on the surface thereof as in 16b, or other suitable surface to ensure there is no slippage between the wheel 16 and end portion 2E. Other measuring devices are known as well which would serve the purpose.

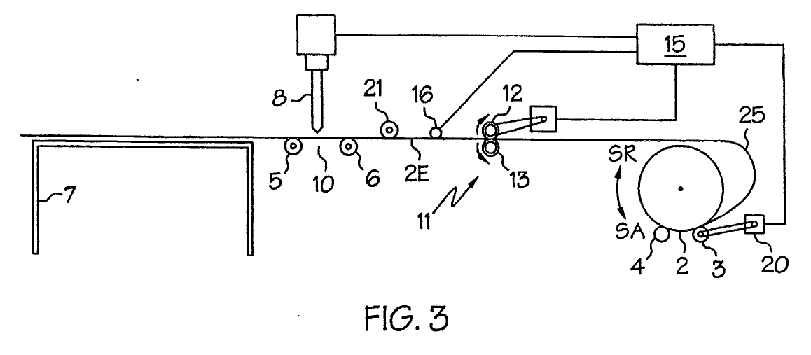

The illustrated apparatus 1 further comprises a coil drive motor 20 connected to rotate coil roller 3 and thereby rotationally drive the sheet metal coil 2 about the coil axis 2A. The computer 15 is operative to control the coil drive motor 20 and selectively rotate the sheet metal coil 2 in a forward sheet advancing direction SA, wherein the sheet metal unrolls off the sheet metal roll 2, and in a reverse sheet retracting direction SR wherein sheet metal rolls onto the sheet metal roll 2. In the embodiment of FIG. 3, the computer 15 is programmed to rotate the sheet metal coil 2 so as to maintain a slack portion 2S of sheet metal between the sheet metal drive 11 and the sheet metal coil 2.

In this manner, the sheet metal drive 11 then does not have to rotate the sheet metal coil 2 but only moves the end portion 2E of sheet metal forwards and rearwards. The inertia of the sheet metal coil 2 can be quite substantial where the coil 2 is large, leading to slippage and jerky motion of the end portion 2E where the inertia must be overcome by the sheet metal drive. Provision of the slack portion 2S much reduces the forces that must be exerted by the sheet metal drive 11.

The apparatus 1 further comprises upper and lower straightening rollers 21, 6 which are operative to flatten the end portion 2E of sheet metal such that same lies flat on the sheet support under the first path X of the cutting head 8. The illustrated roller 6 is both a support roller and a straightening roller.

The apparatus 1 further comprises a guide bearing against the edges 22, 23 of the end portion 2E. A first guide roller 24 is fixed and bears against a first edge 22 and a second guide roller 25 is biased against the opposite second edge 23 of the end portion 2E. The first and second guide rollers 24, 25 are located adjacent to the first path X. A third roller 26 is fixed and bearing against the first edge 22 at a location between the first guide roller 24 and the sheet metal coil 2. A fourth guide roller 27 is biased against the second edge 23 at a location between the second guide roller 25 and the coil 2. The biased rollers 25, 27 allow for variations in the width of the sheet metal.

The apparatus 1 can be operated to cut sheet metal pieces from a sheet metal coil 2 by positioning the end portion 2E from the sheet metal coil 2 to rest on the sheet support rollers 5, 6 and table 7. The cutting head 8 is moved back and forth above the end portion 2E along the first path X and the end portion 2E is moved forward and rearward along the second path Y. The movements of the cutting head 8 and the end portion 2E along the first and second paths X, Y are coordinated by the computer 15 such that the pieces are cut from the sheet metal. The computer also rotates the coil 2 so as to maintain a slack portion 2S of sheet metal between the sheet metal drive 11 and the sheet metal coil 2.

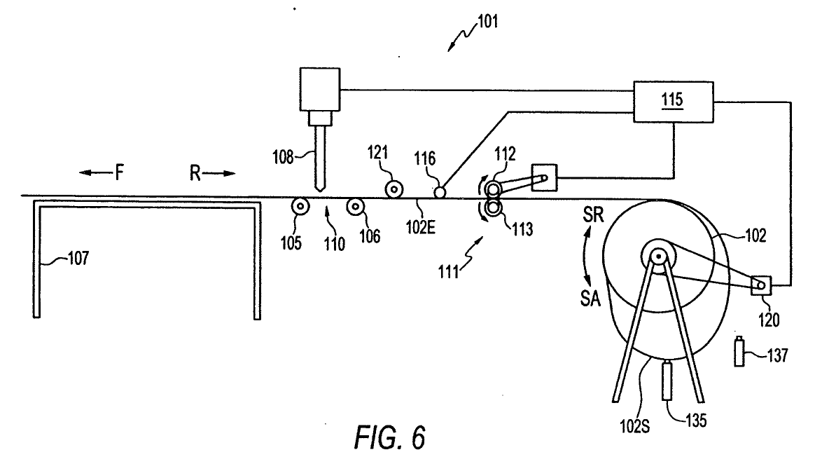

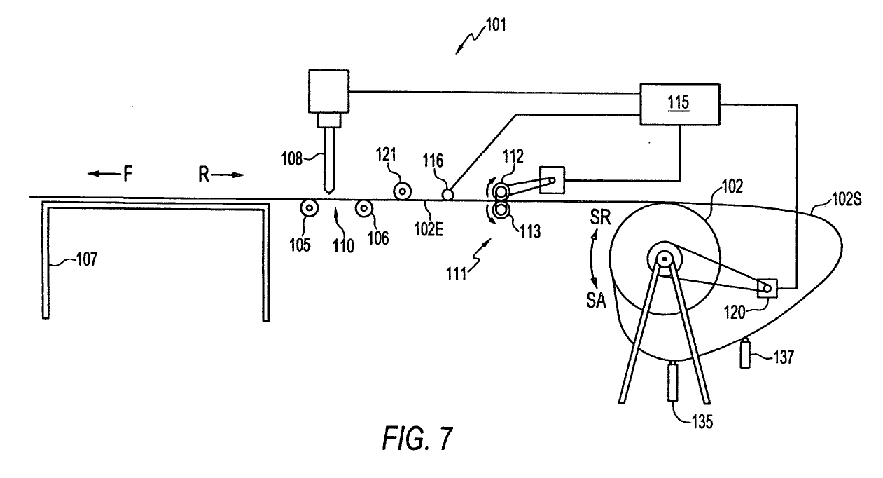

An alternate embodiment of the invention is shown by the apparatus 101 illustrated in FIGS. 6 and 7. The cutting head 108 is mounted above open space 110 between support rollers 105, 106 and above end portion 102E resting on support rollers 105, 106 and on table 107. The sheet metal drive 111 comprises a pair of upper and lower drive rollers 112, 113 driven by sheet drive motor 114 controlled by computer 115 to move the end portion 102E. Upper and lower straightening rollers 121, 106 are operative to flatten the end portion 102E. The illustrated roller 106 is both a support roller and a straightening roller. Measuring wheel 116 measures back and forth movement of the sheet metal.

The coil support comprises a stand 103 and the sheet metal coil 102 comprises a shaft 104 extending therethrough and rotatably mounted to the stand 103. In this alternate embodiment, the coil drive comprises a coil drive motor 20 connected to a sprocket 130 on the shaft 103 by a chain 132 such that the motor 20 is operative to rotate the shaft 103 and thus rotate the coil 102. A belt and pulley, gears, or like connector could also be used to connect the drive motor 20 to rotate the shaft 103.

The apparatus 101 is also configured to maintain a slack portion of sheet metal 102S between the sheet metal drive 111 and the sheet metal coil 102. A minimum slack sensor, illustrated as a first limit switch 135, is operative to detect the slack portion 102S of sheet metal at a minimum slack portion position illustrated in FIG. 6. It can be seen in FIG. 6 that the slack portion 102S is resting on the switch 135, indicating that at least the minimum slack portion is available. Then when the sheet metal drive 111 pulls the sheet metal in the forward direction F, the slack portion 102S will be pulled upward and the limit switch 135 will move, causing the motor 120 to rotate the sheet metal coil 102 in the forward sheet advancing direction SA until the slack portion 102S again contacts the switch 135, indicating that the minimum slack portion of sheet metal is again present, and turning off the motor 20.

The illustrated apparatus 101 also includes a maximum slack sensor, illustrated as a second limit switch 137. When, during a cutting operation, the sheet metal drive 111 pulls the sheet metal rearward in direction R, the slack portion 102S will increase in length and generally take the shape illustrated in FIG. 7. While it is contemplated that in many applications, especially where very long pieces are not being cut, this increase in the length of the slack portion 102S will not be problematic. Where it is problematic however, the second switch 137 is positioned, as illustrated, to contact the slack portion 102S of sheet metal at a maximum slack portion illustrated in FIG. 7, and then control the coil drive motor 120 to rotate the sheet metal coil 102 in a reverse sheet retracting direction SR to maintain the slack portion 102S of sheet metal in a desired range.

Thus in the apparatus 101 of FIGS. 6 and 7, the computer does not need to be programmed to control the coil drive motor 120, but the configuration of the drive and switches automatically maintains the slack portion 102S in the desired range between a minimum slack portion and a maximum slack portion.

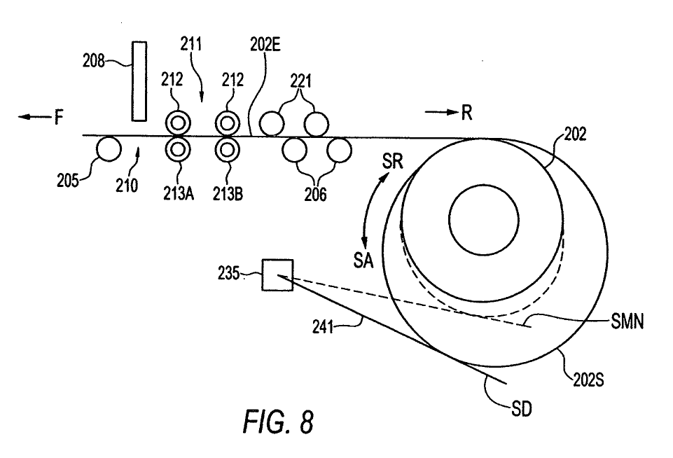

FIG. 8 schematically illustrates a further alternate embodiment of an apparatus 201 of the invention. The cutting head 208 is mounted above open space 210 between support rollers 205, 213A and above end portion 202E. The illustrated sheet metal drive 211 comprises a pair of upper drive rollers 212, and a pair of lower drive rollers 213A, 213B driven by a sheet drive motor controlled by computer. Upper and lower pairs of straightening rollers 221, 206 are operative to flatten the end portion 202E. In this embodiment the straightening rollers 221, 206 are operative to straighten the end portion 202E prior to the drive 211, such that the end portion 202E is pulled through the straightening rollers 221, 206 rather than being pushed through them. Here the roller 213A is both a support roller and a drive roller.

The sheet metal coil 202 is supported on a stand and comprises a shaft extending therethrough and rotatably mounted to the stand. The coil 202 is rotated by a coil drive motor connected to the shaft in the same manner as in the embodiment of FIGS. 6 and 7, and the apparatus 201 is also configured to maintain a slack portion of sheet metal 202S between the sheet metal drive 211 and the sheet metal coil 202. A minimum slack sensor switch 235, has an arm 241 biased upward against the slack portion 202S. When the sheet metal drive 211 pulls the sheet metal in the forward direction F, the slack portion 202S will be pulled upward and the arm 241 will follow the slack portion 202S upward to a minimum slack portion position SMN indicated by phantom lines, at which point the slack sensor switch 235 will cause the coil drive motor to rotate the sheet metal coil 202 in the forward sheet advancing direction SA until the slack portion 202S moves down to the desired position SD, at which point the slack sensor switch 235 will stop the coil drive motor.

When, during a cutting operation, the sheet metal drive 211 pulls the sheet metal rearward in direction R, the slack portion 202S will increase and extend generally rearward and downward from the coil 202. Where the slack portion 202S extends to length that is problematic, a maximum slack sensor can be added to rotate the sheet metal coil 202 in a reverse sheet retracting direction SR to maintain the slack portion 202S of sheet metal in a desired range.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. An apparatus for cutting sheet metal pieces from a sheet metal coil, said sheet metal coil having a coil axis, said apparatus comprising:
a coil support adapted to support said sheet metal coil such that same may rotate about said coil axis to unroll an end portion of said sheet metal coil;
a sheet support adapted to support said end portion for cutting;
a cutting head mounted above said sheet support and end portion and operative to cut through said end portion;
a cutting head drive operative to move said cutting head back and forth along a first path substantially parallel to said coil axis;
a sheet metal drive operative to move said end portion forward and rearward along a second path substantially perpendicular to said coil axis;
a coil drive operable to selectively rotate said sheet metal coil about said coil axis in a forward direction and in a reverse direction; and
a computer operative to control and coordinate said cutting head drive and said sheet metal drive such that said pieces are cut from said end portion.

2. The apparatus of claim 1 wherein said computer is operative to control said coil drive.

3. The apparatus of claim 2 wherein said computer is operative to rotate said sheet metal coil in a forward sheet advancing direction wherein said sheet metal unrolls off said sheet metal coil, and in a reverse sheet retracting direction wherein sheet metal rolls onto said sheet metal coil.

4. The apparatus of claim 3 wherein said computer is programmed to rotate said sheet metal coil so as to maintain a slack portion of sheet metal between said sheet metal drive and said sheet metal coil.

5. The apparatus of claim 1 wherein the apparatus is configured to maintain a slack portion of sheet metal between said sheet metal drive and said sheet metal coil.

6. The apparatus of claim 5 comprising a minimum slack sensor operative to detect the slack portion of sheet metal at a minimum slack portion position and operative to control the coil drive to rotate said sheet metal coil in a forward sheet advancing direction when the slack portion of sheet metal is at the minimum slack portion position.

7. The apparatus of claim 6 comprising a maximum slack sensor operative to detect the slack portion of sheet metal at a maximum slack portion position, and operative to control the coil drive to rotate said sheet metal coil in a reverse sheet retracting direction when the slack portion of sheet metal is at the maximum slack portion position.

8. The apparatus of claim 6 wherein said coil support comprises a stand and said sheet metal coil comprises a shaft extending therethrough and rotatably mounted to said stand, and wherein said coil drive is operative to rotate said shaft.

9. The apparatus of claim 1 wherein said coil support comprises a stand and said sheet metal coil comprises a shaft extending therethrough and rotatably mounted to said stand, and wherein said coil drive is operative to rotate said shaft.

10. The apparatus of claim 1 wherein said coil support comprises a plurality of coil rollers and wherein said sheet metal coil rests on said coil rollers and wherein said coil drive is operative to rotate at least one coil roller.

11. The apparatus of claim 1 further comprising a measuring device operable to transmit information respecting the position of said end portion along said second path to said computer, said computer then using this information to control said sheet metal drive.

12. The apparatus of claim 11 further comprising a measuring device operable to transmit information respecting the position of said end portion along said second path to said computer, said computer then using this information to control said sheet metal drive and said coil drive.

13. The apparatus of claim 11 wherein said measuring device comprises a wheel bearing against a surface of said end portion.

14. The apparatus of claim 1 further comprising a plurality of straightening rollers operative to flatten said sheet metal such that same lies flat on said sheet support.

15. The apparatus of claim 14 wherein said sheet support is oriented such that there is an open space beneath said end portion under said first path such that cutting debris can fall through said open space.

16. The apparatus of claim 15 wherein said sheet support comprises a pair of support rollers defining said open space there-between.

17. The apparatus of claim 1 further comprising a guide bearing against at least one edge of said end portion.

18. The apparatus of claim 17 wherein a first guide roller is fixed and bears against a first edge of said end portion, and a second guide roller is biased against an opposite second edge of said end portion.

19. The apparatus of claim 18 wherein said first and second guide rollers are located adjacent to said first path, and further comprising a third roller fixed and bearing against said first edge of said end portion between said first guide roller and said coil, and a fourth guide roller biased against said second edge of said end portion between said second guide roller and said coil.

20. A method of cutting sheet metal pieces from a sheet metal coil, said sheet metal coil having a coil axis, said method comprising:
positioning an end portion from said sheet metal coil to rest on a sheet support;
moving a cutting head back and forth above said end portion and said sheet support along a first path parallel to said coil axis to cut said end portion;
moving said end portion forward and rearward along a second path perpendicular to said coil axis;
rotating said sheet metal coil to maintain a slack portion of sheet metal between said sheet metal drive and said sheet metal coil;
coordinating the movements of said cutting head and said end portion along said first and second paths with a computer such that said pieces are cut from said end portion.

21. The method of claim 20 comprising maintaining the slack portion of sheet metal in a range between a minimum slack portion and a maximum slack portion.

22. The method of claim 20 further comprising guiding said end portion along said second path.
